(19) United States
(12) Patent Application Publication
(10) Pub. No.: US 2024/0313297 A1
(43) Pub. Date: Sep. 19, 2024

(54) BATTERY SYSTEM INCLUDING A PRESSURE VESSEL AND AN ONBOARD SYSTEM PRESSURIZING THE PRESSURE VESSEL

(71) Applicant: Schaeffler Technologies AG & Co. KG, Herzogenaurach (DE)

(72) Inventors: Matthew WISE, Hamilton, OH (US); Victor NORWICH, Wooster, OH (US); Timothy CHAMBERLAIN, Wooster, OH (US)

(21) Appl. No.: 18/184,402

(22) Filed: Mar. 15, 2023

(51) Int. Cl. H01M 10/6564; B60R 16/033; H01M 10/613; H01M 10/625; H01M 10/6551; H01M 10/663

(52) U.S. Cl. CPC H01M 10/6564; B60R 16/033; H01M 10/613; H01M 10/625; H01M 10/6551; H01M 10/663; H01M 2250/20

(57) ABSTRACT

A battery system is provided including a battery pack including a battery housing and a plurality of battery cells stacked within the battery housing in a stacking direction. Each of the battery cells includes an anode current collector, an anode material on the anode current collector, a cathode current collector, a cathode material on the cathode current collector, and a solid-state electrolyte sandwiched between the anode material and the cathode material for transporting ions between the anode material and the cathode material. The battery system also includes a pressure vessel. The battery pack is inside of the pressure vessel, and the pressure vessel includes a gas inlet and a gas outlet.

### TECHNICAL FIELD

The present disclosure relates generally to solid state electrolyte batteries and more specifically to packaging solid state electrolyte batteries for motor vehicles.

### BACKGROUND

Solid state electrolyte battery cells require a different environment than liquid electrolyte batteries. Accordingly, there is a need for an improved battery enclosure

### SUMMARY

A battery system is provided including a battery pack including a battery housing and a plurality of battery cells stacked within the battery housing in a stacking direction. Each of the battery cells includes an anode current collector, an anode material on the anode current collector, a cathode current collector, a cathode material on the cathode current collector, and a solid-state electrolyte sandwiched between the anode material and the cathode material for transporting ions between the anode material and the cathode material. The battery system also includes a pressure vessel. The battery pack is inside of the pressure vessel, and the pressure vessel includes a gas inlet and a gas outlet.

In examples, the battery system further includes a pressurization system for conveying compressed gas into the pressure vessel via the gas inlet to generate a force on the battery housing for maintaining uniform pressure on each battery cell in the stacking direction, the pressurization system including a gas inlet line feeding into the gas inlet of the pressure vessel and a gas outlet line exiting the gas outlet of the pressure vessel.

In examples, the pressurization system includes a check valve in the gas inlet line for allowing gas to flow into the gas inlet and preventing backflow from the gas inlet.

In examples, the pressurization system includes a control valve connectable downstream of a compressor, the control valve including a first outlet connectable to an input gas line of a condenser for supplying compressed gas to the condenser and a second outlet for supplying compressed gas to the gas inlet line.

In examples, the pressurization system includes a controller configured to control the control valve to control a flow rate into the gas inlet of the pressure vessel based on a specified temperature within the pressure vessel.

In examples, the pressurization system includes a pressure relief valve downstream from the gas outlet of the pressure vessel for regulating a pressure of the compressed gas within the pressure vessel.

In examples, the pressurization system includes a controller configured to control the pressure relief valve to control a pressure of the compressed gas within the pressure vessel based on a specified pressure.

In examples, the battery system further includes an inlet end cap plugging a first open end of the pressure vessel and sealingly surrounding the gas inlet, and an outlet end cap plugging a second open end of the pressure vessel and sealingly surrounding the gas outlet.

In examples, the battery system further includes electrical and/or data wires entering into the pressure vessel via the first open end by passing through the inlet end cap or entering into the pressure vessel via the second open end by passing through the outlet end cap.

In examples, the battery system further includes a heat exchanger inside the pressure vessel and in contact with the battery pack for cooling the battery cells.

In examples, the battery system further includes an inlet coolant line delivering coolant into the pressure vessel and into the heat exchanger via the first open end by passing through the inlet end cap or via the second open end by passing through the outlet end cap; and an outlet coolant line delivering coolant exiting the heat exchanger and out of the pressure vessel via the second open end by passing through the outlet end cap or via the first open end by passing through the inlet end cap.

An onboard system is also provided including the battery system, an HVAC system configured for absorbing heat from a cabin of the motor vehicle and producing heated compressed gas, and a pressurization system configured for receiving the heated compressed gas from the HVAC system and conveying the heated compressed gas into the pressure vessel via the gas inlet.

In examples, the HVAC system includes an evaporator within the cabin of the motor vehicle configured for absorbing heat from the cabin and evaporating the liquid refrigerant into gas; a compressor configured for compressing and heating the gas; and a condenser configured for cooling the heated gas compressed by the compressor and condensing the gas into a liquid.

In examples, the HVAC system further includes a dryer downstream from the pressure relief valve and configured for receiving liquid refrigerant from the condenser; and an expansion valve downstream of the dryer for regulating the flow of liquid refrigerant into the evaporator.

In examples, the pressurization system includes a control valve downstream of the compressor, the control valve including a first outlet connectable to an input gas line of the condenser for supplying the compressed gas to the condenser and a second outlet for supplying the compressed gas to the gas inlet of the pressure vessel.

In examples, the pressurization system includes a check valve in the gas inlet line for allowing gas to flow into the gas inlet and preventing backflow from the gas inlet.

In examples, the pressurization system includes a pressure relief valve for regulating a pressure of the gas within the pressure vessel, the pressure relief valve arranged such that the compressed gas exiting the pressure relief valve merges with the liquid refrigerant output by the condenser.

In examples, the onboard system further includes a heat exchanger inside the pressure vessel and in contact with the battery pack for cooling the battery cells; an inlet coolant line delivering coolant into the pressure vessel and into the heat exchanger via the first open end by passing through the inlet end cap or via the second open end by passing through the outlet end cap; and an outlet coolant line delivering coolant exiting the heat exchanger and out of the pressure vessel via the second open end by passing through the outlet end cap or via the first open end by passing through the inlet end cap.

In examples, the onboard system further includes a cooling loop providing coolant to the inlet coolant line and receiving coolant from the outlet coolant line, the cooling loop including a radiator and a pump, the coolant flowing from the outlet coolant line through the radiator to the pump, the pump configured for pumping the coolant into the heat exchanger via the inlet coolant line.

In examples, the cooling loop includes a heater for providing heat to a cabin heating system of the motor vehicle; a control valve coupled to the outlet coolant line, the control valve including a first outlet for supplying coolant to the radiator and a second outlet for supplying coolant to the heater; and a coolant line extending from the cabin heating system to the pump.

### BRIEF DESCRIPTION OF THE DRAWINGS

The present disclosure is described below by reference to the following drawings, in which:

FIG. 1 shows a battery system according to the present disclosure; and

FIG. 2 shows an onboard system of a motor vehicle.

### DETAILED DESCRIPTION

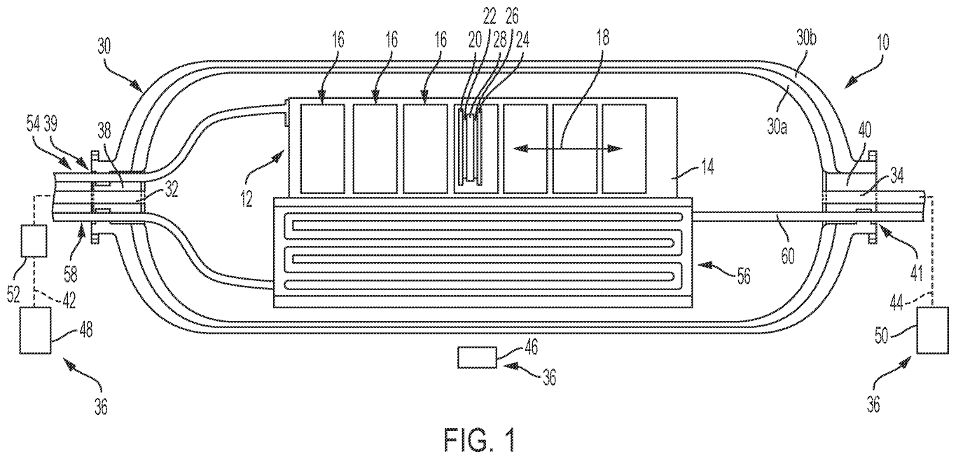

FIG. 1 shows a battery system 10 including a battery pack 12 including a battery housing 14 and a plurality of battery cells 16, which are shown schematically within one of battery cells 16 stacked within the battery housing 14 in a stacking direction 18. Each of the battery cells 16 includes an anode current collector 20, an anode material 22 on the anode current collector 20, a cathode current collector 24, a cathode material 26 on the cathode current collector 24, and a solid-state electrolyte 28 sandwiched between the anode material 22 and the cathode material 26 for transporting ions between the anode material 22 and the cathode material 26.

Anode material 26 can be a lithium metal. Lithium metals forming the anode material 26 can include lithium iron phosphate (LFP), lithium nickel cobalt aluminum oxide (NCA), lithium nickel manganese cobalt oxide (NMC), lithium cobalt oxide (LCO) and lithium manganese oxide (LMO).

Cathode material 30 can be lithium iron phosphate (LFP), lithium nickel cobalt aluminum oxide (NCA), lithium nickel manganese cobalt oxide (NMC), lithium cobalt oxide (LCO), lithium manganese oxide (LMO), lithium titanate (LTO), nickel cobalt aluminum oxide (NCA) or nickel cobalt manganese (NCM).

The anode material 22 of each battery cell 16 expands in the stacking direction 18 during charging and contracts in the stacking direction 18 during discharging, which causes each of battery cells 16 to expand in the stacking direction 18 during charging and to contract in the stacking direction 18 during discharging. If battery cells 16 included liquid electrolytes, this expansion and contraction would not be an issue as liquid electrolyte penetrates both the cathode and anode materials. However, the rigid nature of solid-state electrolyte 28 can cause problems when anode material 22 expands and contracts due to the intercalation/(de)intercalation of the lithium ions into anode material 22 and cathode material 26. It is noted that cathode material 26 can contract in the stacking direction 18 during charging, but to a lesser extent than anode material 22 expands, and can expand in the stacking direction 18 during discharging, but to a lesser extent than anode material 22 contracts.

Battery pack 12, which is a solid-state battery because battery cells 16 include solid-state electrolyte 28, can require anywhere between 0.1-10 MPa of uniform pressure on each battery cell 16 and often must maintain operating temperatures between 20-120 degrees Celsius. Additionally, battery pack 12 can expand and contract drastically during use, with volume changes ranging anywhere between 10-280%.

To prevent problems caused by the expansion and contraction and operating outside of the range of acceptable operating temperatures, battery system 10 includes a pressure vessel 30, which includes a gas inlet 32 and a gas outlet 34, and a pressurization system 36. The battery pack 12 is inside of the pressure vessel 30, which can be formed of a plastic interior layer 30aand a carbon fiber exterior layer 30b surrounding the plastic interior layer 30a. Pressure vessel 30 is provided with an inlet end cap 38 plugging a first open end 39 of the pressure vessel and sealingly surrounding the gas inlet 32, and an outlet end cap 40 plugging the second open end 41 of the pressure vessel 30 and scalingly surrounding the gas outlet 34. End caps 38, 40 can be made of aluminum.

The pressurization system 36 is configured for conveying heated compressed gas into the pressure vessel 30 to provide constant pressure to battery cells 16 during the charging and discharging in order to provide sufficient ionic conductivity between anode material 22 and cathode material 26, and to maintain the operating temperature within the range of acceptable operating temperatures.

Pressurization system 36 is configured for conveying compressed gas into the pressure vessel 30 via the gas inlet 32 to generate a force on the battery housing 14 for maintaining uniform pressure on each battery cell 16 in the stacking direction 18. The pressurization system 36 includes a gas inlet line 42 feeding into the gas inlet 32 of the pressure vessel 30 and a gas outlet line 44 exiting the gas outlet 34 of the pressure vessel 30.

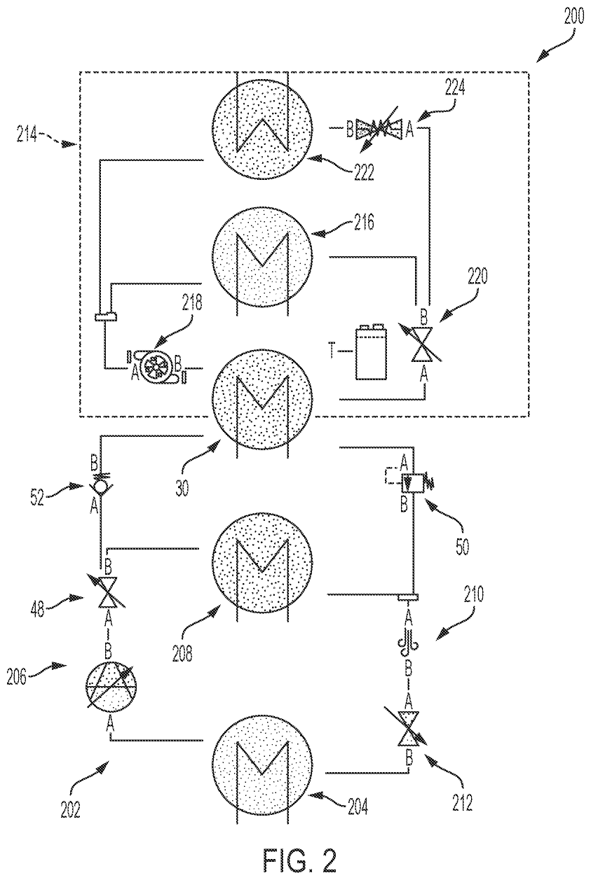

Pressurization system 36 further includes a controller 46 configured to control a flow rate of heated compressed gas to pressure vessel 30 to control the temperature within pressure vessel 30 and configured to control a pressure within the pressure vessel 30 to maintain uniform pressure on each battery cell 16. More specifically, battery system 10 includes a control valve 48 in gas inlet line 42 and a pressure relief valve 50 in gas outlet line 44. Controller 46 is configured to control a flow rate of heated compressed gas to pressure vessel 30 by sending control signals to control valve 48 and to control the pressure within the pressure vessel 30 by sending control signals to pressure relief valve 50. Pressure relief valve 50 also maintains the pressure of battery pack 12 when the vehicle HVAC system 202 (FIG. 2) is shut off. The pressurization system 36 includes a check valve 52 in the gas inlet line 42 for allowing compressed gas to flow into the gas inlet 32 and preventing backflow from the gas inlet 32.

Battery system 10 further includes a cable 54 enclosing wires entering into the pressure vessel via the first open end 39 by passing through the inlet end cap 38. Alternatively, cable 54 can enter into the pressure vessel 30 via the second open end 41 by passing through the outlet end cap 40. The wires can be high voltage electrical wires or data wires, and cable 54 connects directly to the battery pack 12.

The battery system 10 can further include a heat exchanger 56 inside the pressure vessel 30 and in contact with the battery pack 12 for cooling the battery cells 16. An inlet coolant line 58 is provided for delivering coolant into the pressure vessel 30 and into the heat exchanger 56 via the first open end 39 by passing through the inlet end cap 38. An outlet coolant line 60 is provided for delivering coolant out of the pressure vessel 30 and away from heat exchanger 56 via the second open end 41 by passing through the outlet end cap 40. Alternatively, inlet coolant line 58 can enter via second open end 41 and outlet coolant line 60 can exit via first open end 39.

FIG. 2 includes an onboard system 200 of a motor vehicle that includes battery system 10. Onboard system 200 further includes an HVAC system 202 configured for absorbing heat from a cabin of the motor vehicle and producing heated compressed gas that is supplied to pressurization system 36. The heated compressed gas can advantageously be carbon dioxide. The HVAC system 202 includes an evaporator 204 within the cabin of the motor vehicle configured for absorbing heat from the cabin and evaporating liquid refrigerant into gas. HVAC system 202 further includes a compressor 206 configured for compressing and heating the gas, and a condenser 208 configured for cooling the heated compressed output by the compressor 206 and condensing the gas into a liquid.

The control valve 48 is provided directly downstream of compressor 206 and is configured for directing the heat compressed output by the compressor 206 to gas inlet line 42 of pressurization system 36 and/or to the condenser 208. The heated compressed gas can thus be directed to gas inlet line 42 through the check valve 52 and into pressure vessel 30 to heat the battery cells 16 and pressurize pressure vessel 30 to maintain sufficient contact between the battery cells 16.

The gas exiting pressure vessel 30 flows in gas outlet line 44 through pressure relief valve 50 to merge with the liquid refrigerant output by condenser 208. The HVAC system 202 further includes a dryer 210 downstream from the pressure relief valve and configured for receiving liquid refrigerant from condenser 208, which has merged with the gas in gas outlet line 44. An expansion valve 212 of HVAC system 202 is downstream of the dryer 210 for regulating the flow of liquid refrigerant into evaporator 204.

Onboard system 200 further includes a comprising cooling loop 214 providing coolant to the inlet coolant line 58 and receiving coolant from the outlet coolant line 60. Cooling loop 214 utilizes components of HVAC system 202 to provide coolant to heat exchanger 56 to cool battery cells 16 of battery pack 12. The coolant can advantageously be water. The cooling loop 214 includes a radiator 216 and a pump 218. The coolant flows from the outlet coolant line 60 through the radiator 216, which removes heat from the coolant exiting pressure vessel 30 in outlet coolant line 60, to the pump 218. The pump 218 is configured for pumping the coolant into the heat exchanger 56 via the inlet coolant line 58.

The cooling loop 214 also includes a control valve 220 in outlet coolant line 60. Control valve 220 includes a first outlet for providing coolant output from pressure vessel 30 to an inlet of radiator 216 and a second outlet for providing the coolant output from pressure vessel 30 to a cabin heating system 222, which is part of HVAC system 202 and heats the cabin of the motor vehicle. Upstream of cabin heating system 222, cooling loop 214 includes a heater 224 for providing heat to the cabin heating system 222. Heater 224 can be a positive temperature coefficient (PTC) heater. Cabin heating system 222 can include a heater core for removing the heat from the coolant passing therethrough and a blower for blowing the heat into the cabin. Coolant exiting cabin heating system 222 is thus cooled, and can also be provided to pump 218 by a coolant line extending from the cabin heating system 222 to the pump 218, and pumped through inlet coolant line 58 into pressure vessel 30 to cool battery cells 16.

In the preceding specification, the present disclosure has been described with reference to specific exemplary embodiments and examples thereof. It will, however, be evident that various modifications and changes may be made thereto without departing from the broader spirit and scope of the present disclosure as set forth in the claims that follow. The specification and drawings are accordingly to be regarded in an illustrative manner rather than a restrictive sense.

### LIST OF REFERENCE CHARACTERS

10 battery system
12 battery pack
14 battery housing
16 battery cells
18 stacking direction
20 anode current collector
22 anode material
24 cathode current collector
26 cathode material
28 solid-state electrolyte
30 pressure vessel
30a plastic interior layer
30b carbon fiber exterior layer
32 gas inlet
34 gas outlet
36 pressurization system
38 inlet end cap
39 first open end
40 outlet end cap
41 second open end
41by second open end
42 gas inlet line
44 gas outlet line
46 controller
48 control valve
50 pressure relief valve
52 check valve
54 cable
56 heat exchanger
58 inlet coolant line
60 outlet coolant line
200 onboard system
202 HVAC system
204 evaporator
206 compressor
208 condenser
210 dryer
212 expansion valve
214 cooling loop
216 radiator
218 pump
220 control valve
222 cabin heating system
224 heater

What is claimed is:

1. A battery system comprising:
a battery pack including a battery housing and a plurality of battery cells stacked within the battery housing in a stacking direction, each of the battery cells comprising:
an anode current collector;
an anode material on the anode current collector;
a cathode current collector;
a cathode material on the cathode current collector; and
a solid-state electrolyte sandwiched between the anode material and the cathode material for transporting ions between the anode material and the cathode material;
a pressure vessel, the battery pack being inside of the pressure vessel, the pressure vessel including at least one of a gas inlet and a gas outlet.

2. The battery system as recited in claim 1 further comprising a pressurization system for conveying compressed gas into the pressure vessel via the gas inlet to generate a force on the battery housing for maintaining uniform pressure on each battery cell in the stacking direction, the pressurization system including a gas inlet line feeding into the gas inlet of the pressure vessel and a gas outlet line exiting the gas outlet of the pressure vessel.

3. The battery system as recited in claim 2 wherein the pressurization system includes a check valve in the gas inlet line for allowing gas to flow into the gas inlet and preventing backflow from the gas inlet.

4. The battery system as recited in claim 2 wherein the pressurization system includes a control valve connectable downstream of a compressor, the control valve including a first outlet connectable to an input gas line of a condenser for supplying compressed gas to the condenser and a second outlet for supplying compressed gas to the gas inlet line.

5. The battery system as recited in claim 4 wherein the pressurization system includes a controller configured to control the control valve to control a flow rate into the gas inlet of the pressure vessel based on a specified temperature within the pressure vessel.

6. The battery system as recited in claim 2 wherein the pressurization system includes a pressure relief valve downstream from the gas outlet of the pressure vessel for regulating a pressure of the compressed gas within the pressure vessel.

7. The battery system as recited in claim 6 wherein the pressurization system includes a controller configured to control the pressure relief valve to control a pressure of the compressed gas within the pressure vessel based on a specified pressure.

8. The battery system as recited in claim 1 further comprising an inlet end cap plugging a first open end of the pressure vessel and sealingly surrounding the gas inlet, and an outlet end cap plugging a second open end of the pressure vessel and sealingly surrounding the gas outlet.

9. The battery system as recited in claim 8 further comprising electrical and/or data wires entering into the pressure vessel via the first open end by passing through the inlet end cap or entering into the pressure vessel via the second open end by passing through the outlet end cap.

10. The battery system as recited in claim 8 further comprising:
a heat exchanger inside the pressure vessel for cooling the battery cells.

11. The battery system as recited in claim 10 further comprising:
an inlet coolant line delivering coolant into the pressure vessel and into the heat exchanger via the first open end by passing through the inlet end cap or via the second open end by passing through the outlet end cap; and
an outlet coolant line delivering coolant exiting the heat exchanger and out of the pressure vessel via the second open end by passing through the outlet end cap or via the first open end by passing through the inlet end cap.

12. An onboard system of a motor vehicle comprising:
a battery system comprising:
a battery pack including a battery housing and a plurality of battery cells stacked within the battery housing in a stacking direction;
a pressure vessel, wherein the battery pack is inside of the pressure vessel and the pressure vessel includes at least one of a gas inlet and a gas outlet;
an HVAC system configured for absorbing heat from a cabin of the motor vehicle and producing heated compressed gas; and
a pressurization system configured for receiving the heated compressed gas from the HVAC system and conveying the heated compressed gas into the pressure vessel via the gas inlet.

13. The onboard system as recited in claim 12 wherein the HVAC system comprises:
an evaporator within the cabin of the motor vehicle configured for absorbing heat from the cabin and evaporating a liquid refrigerant into gas;
a compressor configured for compressing and heating the gas; and
a condenser configured for cooling the heated gas compressed by the compressor and condensing the gas into a liquid.

14. The onboard system as recited in claim 13 wherein the HVAC system further comprises:
a dryer downstream from a pressure relief valve and configured for receiving the liquid refrigerant from the condenser; and
an expansion valve downstream of the dryer for regulating the flow of the liquid refrigerant into the evaporator.

15. The onboard system as recited in claim 13 wherein the pressurization system includes a control valve downstream of the compressor, the control valve including a first outlet connectable to an input gas line of the condenser for supplying the compressed gas to the condenser and a second outlet for supplying the compressed gas to the gas inlet of the pressure vessel.

16. The onboard system as recited in claim 12 wherein the pressurization system includes a check valve in the gas inlet line for allowing gas to flow into the gas inlet and preventing backflow from the gas inlet.

17. The onboard system as recited in claim 12 wherein the pressurization system includes a pressure relief valve for regulating a pressure of the gas within the pressure vessel, the pressure relief valve arranged such that the compressed gas exiting the pressure relief valve merges with the liquid refrigerant output by the condenser.

18. The onboard system as recited in claim 12 further comprising:
a heat exchanger inside the pressure vessel and in contact with the battery pack for cooling the battery cells;
an inlet coolant line delivering coolant into the pressure vessel and into the heat exchanger via a first open end by passing through an inlet end cap or via a second open end by passing through an outlet end cap; and
an outlet coolant line delivering coolant exiting the heat exchanger and out of the pressure vessel via the second open end by passing through the outlet end cap or via the first open end by passing through the inlet end cap.

19. The onboard system as recited in claim 18 further comprising a cooling loop providing coolant to the inlet coolant line and receiving coolant from the outlet coolant line, the cooling loop including a radiator and a pump, the coolant flowing from the outlet coolant line through the radiator to the pump, the pump configured for pumping the coolant into the heat exchanger via the inlet coolant line.

20. The onboard system as recited in claim 19 wherein the cooling loop comprises:
a heater for providing heat to a cabin heating system of the motor vehicle;
a control valve coupled to the outlet coolant line, the control valve including a first outlet for supplying coolant to the radiator and a second outlet for supplying coolant to the heater; and
a coolant line extending from the cabin heating system to the pump.
